(19) United States
(12) Patent Application Publication
(10) Pub. No.: US 2015/0356627 A1
(43) Pub. Date: Dec. 10, 2015

(54) SOCIAL MEDIA ENABLED ADVERTISING

(71) Applicant: Google Inc., Mountain View, CA (US)

(72) Inventors: Emily K. Moxley, San Francisco, CA (US); Daniel W. Dulitz, Los Altos, CA (US)

(21) Appl. No.: 14/826,709

(22) Filed: Aug. 14, 2015

Related U.S. Application Data
(63) Continuation of application No. 13/086,562, filed on Apr. 14, 2011.
(60) Provisional application No. 61/324,647, filed on Apr. 15, 2010.

(51) Int. Cl. G06Q 30/02; G06Q 50/00

(52) U.S. Cl. CPC G06Q 30/0269; G06Q 50/01; G06Q 30/0277

(57) ABSTRACT

Methods, systems, and apparatus, including computer programs encoded on a computer storage medium, for social media advertising. In one aspect, a method includes associating keywords with a social media network property of an advertiser, periodically obtaining from the social media network property content on the social media network property of the advertiser, receiving a keyword for an advertisement request for a user device, determining that the received keyword is one of the keywords associated with the social media network property and in response to the determination generating an advertisement responsive to the request, the advertisement including at least some of the content obtained from the social media network property, providing the advertisement for display on a user device.

### CROSS-REFERENCE TO RELATED APPLICATIONS

This application is a continuation application of, and claims priority to, U.S. patent application Ser. No. 13/086,562, titled “SOCIAL MEDIA ENABLED ADVERTISING,” filed on Apr. 14, 2011, which claims the benefit under 35 U.S.C. §119(e) of U.S. Patent Application No. 61/324,647, titled “SOCIAL MEDIA ENABLED ADVERTISING,” filed Apr. 15, 2010. The disclosure of the foregoing applications are incorporated herein by reference in their entirety for all purposes.

### BACKGROUND

This specification relates to on-line advertising.

The Internet enables access to a wide variety of content items, e.g., video and/or audio files, web pages for particular subjects, news articles, etc. Such access to these content items likewise enables opportunities for targeted advertising. For example, advertisements can be provided with search results in response to a search query provided by a user; provided by third party online publishers that place the advertisement on web pages that have content related to the advertisement; or provided in response to a specific request from a user, such as when a user requests information for particular products or services.

Social media networks enable members to update their followers in real time with information. Similar to an open journal or diary, individual members maintain a social media network property, which they use to immediately communicate information to their users. Social media networks are open to both individuals and businesses, and thus a business/advertiser (“advertiser”) may have an account on a social network and maintain a social network property. Many advertisers maintain social network properties, and often update these properties on a daily, hourly, or even minute-by-minute basis.

Often advertisers do marketing and branding broadcasts on social network properties and media streams (e.g., videos, blogs posts and/or messages) generated from the social network properties. These campaigns are also used to connect users and advertisers for customer service operations, increasing brand recognitions, and other objectives of a campaign. Typically, however, the campaigns that are managed on social networks are not fully integrated with campaigns on other properties, such as web search properties and publisher properties.

### SUMMARY

This specification describes technologies relating to on-line advertising.

In general, one aspect of the subject matter described in this specification can be embodied in methods that include the actions of associating, by the data processing apparatus, keywords with a social media network property of an advertiser; receiving a keyword for an advertisement request for a user device; determining that the received keyword is one of the keywords associated with the social media network property and in response to the determination: obtaining, by the data processing apparatus and from the social media network property, content on the social media network property by the advertiser; generating, by the data processing apparatus, an advertisement responsive to the request, the advertisement including at least some of the content obtained from the social media network property; and providing the advertisement for display on the user device. Other embodiments of this aspect include corresponding systems, apparatus, and computer programs, configured to perform the actions of the methods, encoded on computer storage devices.

Another aspect of the subject matter described in this specification can be embodied in methods that include the actions of associating, by the data processing apparatus, keywords with a social media network property of an advertiser; periodically obtaining, by the data processing apparatus and from the social media network property, content on the social media network property by the advertiser; receiving a keyword for an advertisement request for a user device; determining that the received keyword is one of the keywords associated with the social media network property and in response to the determination generating, by the data processing apparatus, an advertisement responsive to the request, the advertisement including at least some of the content obtained from the social media network property; and providing the advertisement for display on the user device. Other embodiments of this aspect include corresponding systems, apparatus, and computer programs, configured to perform the actions of the methods, encoded on computer storage devices.

Another aspect of the subject matter described in this specification can be embodied in methods that include the actions of associating a keyword with a social media network property of an advertiser; storing the keyword in a datastore; receiving an advertisement request including one or more keywords; comparing the received one or more keywords of the advertisement request to the stored keywords in the database/data store to identify relevant social media network property and in response to the identification; retrieving, by the data processing apparatus and from the social media network property, content on the social media network property by the advertiser; creating, by the data processing apparatus, an advertisement responsive to the request, the advertisement including at least a subset/portion of the content retrieved from the social media network property; and providing the advertisement for display on the user device.

Another aspect of the subject matter described in this specification can be embodied in methods that include the actions of receiving an advertisement request from a user device; determining if the advertisement request is associated with social network property of an advertiser; upon determining that the advertisement request is associated with social media network property of an advertiser: obtaining, by the data processing apparatus and from the social media network property, content on the social media network property by the advertiser; and generating, by the data processing apparatus, an advertisement responsive to the request, the advertisement including at least a subset/portion of the content obtained from the social media network property; and upon determining that the advertisement request is not associated with social network property of the advertiser: obtaining, by the data processing apparatus, an advertisement; and presenting the advertisement for display on the user device.

The foregoing and other embodiments can each optionally include one or more of the following features, alone or in combination. The keywords may be provided by the advertiser. Associating keywords with a social media network property may include determining keywords based on the content on the social media network property. The methods may also include the actions of prioritizing content based on statistics that measure repeating of content by users on at least one social media network. Content may be filtered based on the keywords. Generating an advertisement responsive to the request may include generating an advertisement that includes content from an advertising campaign and content from the social media network property separate from the advertising campaign. Generating an advertisement responsive to the request may include determining whether the user device is associated with an account on the social media network; in response to determining that the user device is not associated with an account on the social media network, generating an advertisement that includes only content from the social media network property; and in response to determining that the user device is associated with an account on the social media network, generating an advertisement that includes content from the social media network property and one or more social network commands specific to two or more users of the social network. The content may include blog posts. The content may include RSS feed data. The content may include images. Generating an advertisement responsive to the request may include determining whether the user device is associated with an account on the social media network; in response to determining that the user device is not associated with an account on the social media network, generating an advertisement that includes only content from the social media network property; in response to determining that the user device is associated with an account on the social media network, generating an advertisement that includes content from the social media network property and one or more social network commands specific to two or more users of the social network. Obtaining an advertisement may include identifying an application template; generating an advertisement based on the application template and information provided by the user device.

Particular embodiments of the subject matter described in this specification can be implemented to realize one or more of the following advantages. Advertisements can include the most current information provided by the advertiser on a social network site. Advertisements may reflect content that the audience finds the most interesting. Advertisements may be integrated with social media networks. Advertisement creation may be simplified.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which advertisements can be targeted to users.

FIG. 2 is a block diagram of an exemplary environment in which the advertisement management system may operate in conjunction with a social media network.

FIG. 3 is a block diagram showing how information from a social media property may be incorporated into advertisements, according to an example embodiment.

FIGS. 4A and 4B show keywords submitted by a client device affecting the resulting advertisement, according to an example embodiment.

FIG. 5 is a block diagram showing prioritization of social media content, according to an example embodiment.

FIGS. 6A-6C illustrate exemplary user interfaces for delivering advertisements based on social media content.

FIG. 7 is a flow diagram of an example process for creating advertisements based on social media content on a social media property.

Like reference numbers and designations in the various drawings indicate like elements.

### DETAILED DESCRIPTION

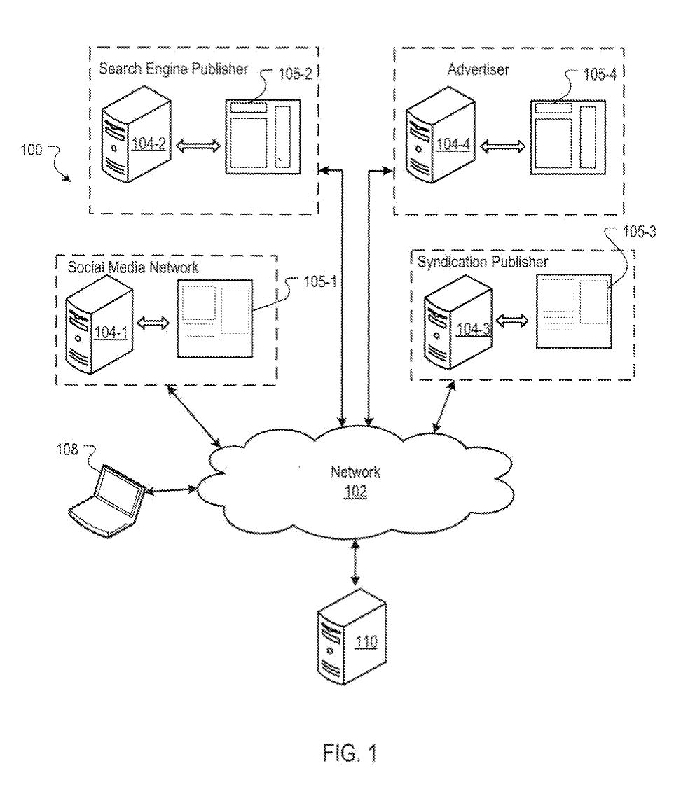

FIG. 1 is a block diagram of an example environment in which advertisements can be targeted to users. A computer network 102, such the Internet, or a combination of Internet and one or more wired and wireless networks, connects one or more social media network publishers 104-1, a search engine publisher 104-2, one or more syndication publishers 104-3, one or more advertisers 104-4, a user device 108, and an advertisement management system 110. For clarity, only three publishers and one advertiser are shown; however, the online environment 100 includes many thousands of publishers and advertisers.

The user device 108 is an electronic device that is under control of a user and is capable of requesting and receiving resources 105 over the network 102. Example user devices 108 include personal computers, mobile communication devices and other devices that can send and receive data over the network 102. A user device 108 typically includes a user application, such as a web browser or other communication software, to facilitate the sending and receiving of data over the network 102.

The publishers and, optionally, the advertisers 104 maintain websites that are one or more resource 105 associated with a domain name, and each web site is hosted by one or more servers. A resource is any data that can be provided by the web site over the network 102 and that is associated with a resource address. Resources include HTML pages, RSS feeds, blog posts, and video, for example. To avoid congestion in the drawings, the resources 105 are represented as web pages; however, the representations of FIG. 1 are inclusive of all types of resources that are consistent with the above definition.

As will be described in more detail below, each of the publishers are in data communication with the advertisement management system 110 and together the publishers and the advertisement management system 110 facilitate the provisioning of advertisement with the publisher resources 105. In particular, the advertisement management system 110 allows advertisers to define targeting rules that take into account attributes of the particular user to generate targeted advertisement offers for the users.

These targeted advertisements can be provided in many different properties, such as the properties of the social media network publisher 104-1, the search engine publisher 104-2, and the syndication publisher 104-3. For example, the search engine publisher 104-2 is a search service that provides advertisements to users with search results that are responsive to user queries. Typically, the search results are provided in one part of the page, such as the left-hand side, and the advertisements are provided in another part of the page, such as the right-hand side of the page. When the search engine publisher 104-2 provides the search results webpage 105-2 to the user device 108, the user device renders the webpage 105-2. The webpage 105-2 includes instructions that cause the user device to request advertisements from the advertisement management system 110. The request will include a user identifier and other data regarding the search, such as the user query, and the advertisement management system 110 can provide targeted advertisements to the particular user.

The syndication publisher 104-3 is a general content web site, e.g., a sports related web site, a news related web site, etc. When a user device 108 receives a resource 105-3 from the syndication publisher 104-3, the user device renders the resource 105-3. As with the search results page, the webpage 105-3 includes instructions that cause the user device to request advertisements from the advertisement management system 110. The request will include a user identifier and other data that describes the content of the webpage 105-3, and the advertisement management system 110 can provide targeted advertisements to the particular user.

Like the syndication publisher 104-3, the social media network publisher 104-1 can also provide resources on which advertisements are rendered. However, the advertising management system 110 also facilitates the collection of content that has been posted on the social media network publisher 104-1 property of a particular advertiser for inclusion in advertisements on other properties, such as the search engine publisher 104-2 and other syndication publishers 104-3. In general, an advertiser that maintains an account at both the advertisement management system and the social media network publisher 104-1 can specify that, under one or more conditions, content from the social media network property 104-1 be included in advertisements for the advertiser.

For example, the advertiser may specify that certain keywords that are used in search queries or collected from web pages on which advertisements are to be rendered be associated with the content of its corresponding social network property. For advertisements that are generated in response to those keywords, the advertisements can include text, streams, or other data collected from the social network property.

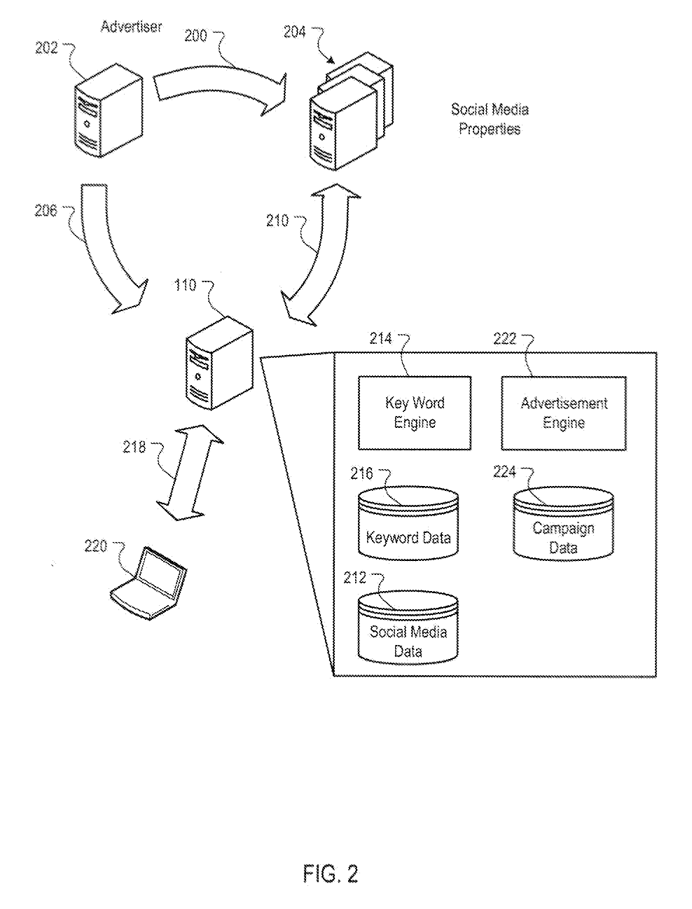

FIG. 2 is a block diagram of an exemplary environment in which the advertisement management system 110 may operate in conjunction with a social media network. Represented by process arrow 200, an advertiser 202 maintains one or more social media properties 204. Generally, the social media properties are hosted by a social media network; however, in some circumstances, the social media property may be hosted by the advertiser. Represented by process arrow 206, the advertiser registers the social media network account with the advertisement management system 208. By doing so, the advertiser allows the advertisement management system 110 to access the advertiser's data and content at the social media network property 204. For example, the advertisement management system 110 may have an application program interface (API), or some other instrument, that allows the advertisement management system 110 to access the social media network property 204.

As indicated by the process arrow 210, the advertisement management system accesses the social media properties 204 of the advertiser to obtain information posted on the social media property by the advertiser. In some embodiments, the content from the social media property is stored by the advertisement management system in a social media data store 212 for rapid retrieval. In some implementations, the content is periodically obtained, e.g., hourly, by the advertisement management system so that recent content can be included in advertisements. In other implementations, the information from the social media property is accessed by the advertisement management system in response to an advertisement request, the latter of which is described in more detail below.

The advertisement management system associates information from the advertiser and the advertiser's social media properties with one or more keywords. The keywords may be supplied by the advertiser, or suggested by the advertisement management system 110 and accepted by the advertiser. In some implementations, the keywords can be obtained by analyzing the social media content from the social media property of the advertiser. For example, the advertisement management system includes a key word engine 214 that analyzes the social media content from the social media site of the advertiser to obtain keywords. Once obtained, the advertisement management system stores the keyword data in a keyword data store 216.

Represented by process arrow 218, a client device 108 causes keywords to be sent to the advertisement management system. For example, the client device 108 may request search results from a search engine publisher, and when the client device renders the search results page, the page may cause the client device to send an advertisement requests that includes one or more keywords to the advertisement management system.

The advertisement management system stores information advertising campaigns of the advertiser in a campaign data store 224. An example campaign specifies advertising budgets for advertisements, and specifies when, where and under what conditions particular advertisements may be served for presentation.

The advertisement management system includes and advertisement engine 222. The advertisement engine compares the keywords to the keywords in the keyword data store 216 to identify relevant social media content. The comparison can include one or more data models that predict advertisement performance, and can take into account the predicted performance, quality scores, and auction bids to determine which advertiser will have advertisements shown.

The advertisement engine combines campaign information with the social media data to create a tailored advertisement. Alternatively, the advertisement engine may provide multiple advertisements, some specific to the campaign (e.g., an advertisement with a pre-generated creative and image) and some generated from social media content.

For example, assume that the advertiser 202 wins at least one advertisement slot in the auction, or otherwise is selected to have an advertisement shown in response to the advertisement request. The advertisement engine 222 determines if the keyword or advertisement request is associated with the social network property of the advertiser. If the keyword or advertisement request is not associated with the social network property of the advertiser, then the advertisement selected may be from an existing advertisement or advertisement templates specified for the campaign. An existing advertisement, may be, for example, an existing banner advertisement, image, flash application, or other conventional advertisement. An advertisement template may be, for example, an advertisement in which the advertisement engine 222 may personalize the advertisement for the recipient based on information provided by the user device. For example, the advertisement engine 222 may include a local address where the advertised good or service may be acquired. The user may have identified himself to the service and the advertisement may be personalized with the user's reported name or user identifier.

Conversely, if the keyword or advertisement request is associated with the social network property of the advertiser, then the advertisement engine 222 creates an advertisement from the social media data and provides it to the client device for display. For example, the advertisement may be an image, text, html, or any other form of presentable data that was recently posted by the advertiser on the social network property, e.g., within the last five minutes.

In some embodiments, the advertisement engine may filter the social media data based on the keyword in order to obtain more relevant information. For example, suppose the advertiser has a social network property related to sports apparel and sports gear, and the advertiser is posting entries and RSS feed data related to the release of a spring line of apparel and the introduction of new mountaineering equipment. Assuming the keywords for the advertisement request are “compression shorts,” then only data related to the release of the spring line of apparel will be considered for inclusion in the advertisements, as compression shorts are more relevant to apparel than to mountaineering equipment.

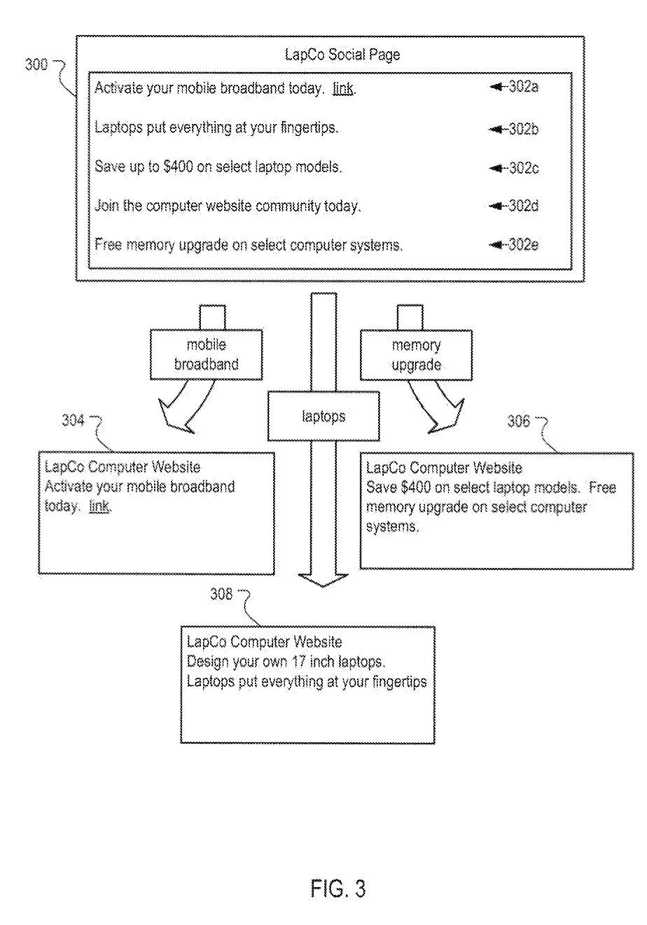

FIG. 3 is a block diagram showing how content from a social media property may be incorporated into advertisements. In this example, a social media property page 300 includes social media content 302a-e for an advertiser. The content may be combined in different ways to create different advertisements. Assume that the social media property page 300 is a page in which the advertiser can post short messages and the posts can be automatically sent to other users that have elected to receive the posts from the advertiser as they are posted. Other social media property page 300 pages can also be used, however.

The advertiser, “LapCo,” is illustratively a provider of mobile devices and laptops, and uses the social media property page 300 to announce new developments, product releases, and general posts that may be of interests to consumers.

As shown with advertisement 304, a single entry from the social network property, here “Activate your mobile broadband today” 302a, may be turned directly into an advertisement 304 in response to an advertisement request that includes the keywords “mobile broadband.” The advertisement includes additional information identifying the source of the content. In some scenarios, an HTML link embedded in the entry is transposed and embedded in the advertisement. If the text of the HTML link is too long to fit into the advertisement, the displayed link text may be abbreviated.

As shown with advertisement 306, content from several entries may be combined to form a single advertisement for a request that includes the keyword “laptops.” Here, social media content 302c and 302e related to the sale of a new laptop computer systems are grouped together. In addition to grouping the content together based on keywords or other metadata supplied by the advertiser, social media content may be grouped based on their content (for example, phrases such as “save” and “free” may indicate that the social media content are associated with a limited time sale).

As shown in advertisement 308, content on the social media network property may be integrated with existing marketing campaign, e.g., a marketing campaign that offers free memory upgrades. Existing advertising campaigns may be associated with social media content on the social media network property. In some embodiments, the existing campaign may be associated with keywords, which are used to select social media content that may be combined to create new advertisements. In this example, an existing campaign suggesting customers “Design your own laptop” is integrated with a social media entry “Laptops put everything at your fingertips” 302b. In other embodiments, keywords may be identified from the text of the advertisement campaign itself.

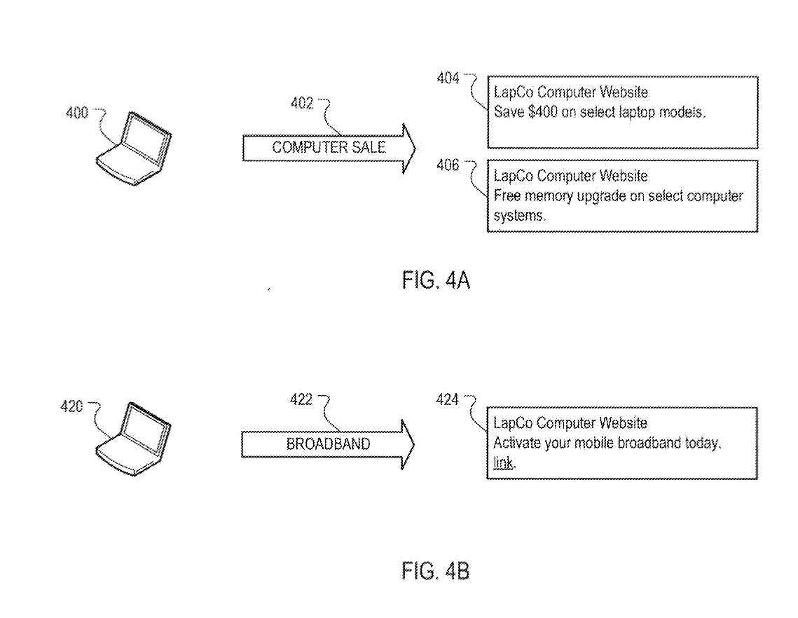

FIGS. 4A and 4B show other examples of keywords submitted by a client device affecting the resulting advertisement. As described above, keywords submitted by the client device may affect not only which advertiser's advertisements are presented, but also which social media content from a social media property are incorporated into advertisements. For example, referring to FIG. 4A, as represented by process arrow 402, a client device 400 submits the keywords “Computer Sale” to the advertising management system. As a result the advertising management system creates advertisements 404, 406 from the social media network property social media content related to the computer sales.

Similarly, referring to FIG. 4B, represented by process arrow 422, a client device 420 submits the keyword broadband to the advertisement management system. In response, the advertisement management system creates an advertisement 424 (“Activate your mobile broadband today”) related to broadband.

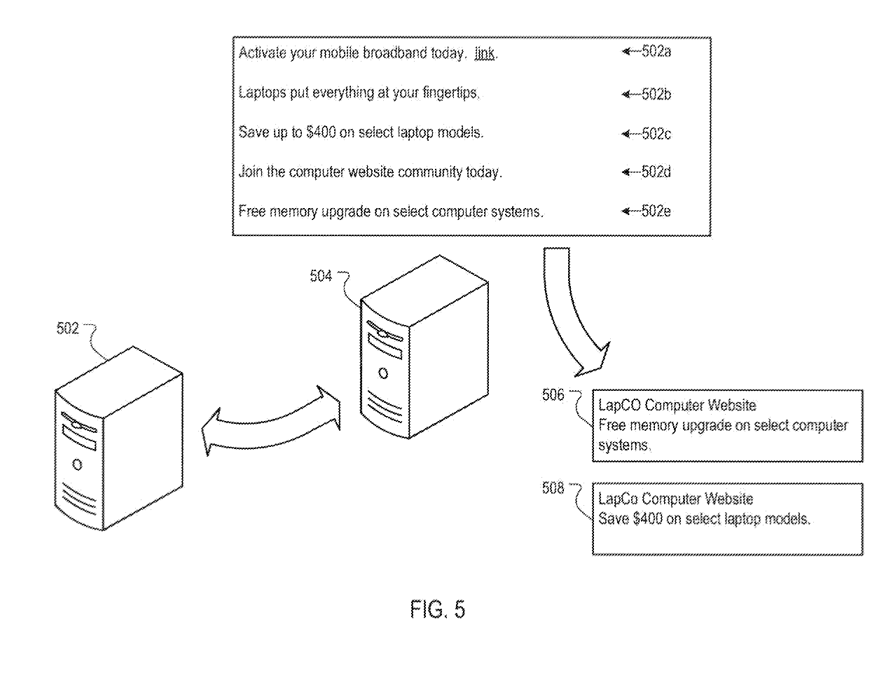

FIG. 5 is a block diagram showing prioritization of social media content. As described above, multiple different social media content may by appropriate to transform into advertisements. For example, referring to FIG. 5, when selecting between multiple different social media content 500a-e, the content may be prioritized based on the popularity of the content. Many social media properties 502 have mechanisms by which a user of the social media may rate or indicate popularity of particular content. For example, users may indicate their acceptance of a particular post on a Likert scale, e.g., a rating from 1-5 stars.

Another signal of popularity is repeating the content. As used herein, “repeating content” is the act of a user propagating content that the user receives, and includes a user re-sending content that is received, e.g., by forwarding or re-posting the content. For example, users may re-send microblog posts that they receive from an advertiser. Content that is repeated by many different users are more likely to make high performing advertisements than content that is not.

The advertisement management system 504 may interact with the social media property 502 to determine which social media content is most popular, e.g., by receiving statistics related to particular content provided by the advertiser. The advertisement management system prioritizes the social media content that is more popular over social media content that is less popular Here, assume the entry “Free memory upgrades on selected computer systems” 500e is more popular than the entry “Save $400 on select desktop models” 500c. Therefore an advertisement 506 based on the free memory content post is given higher preference than an advertisement 508 based on the $400 discount content post.

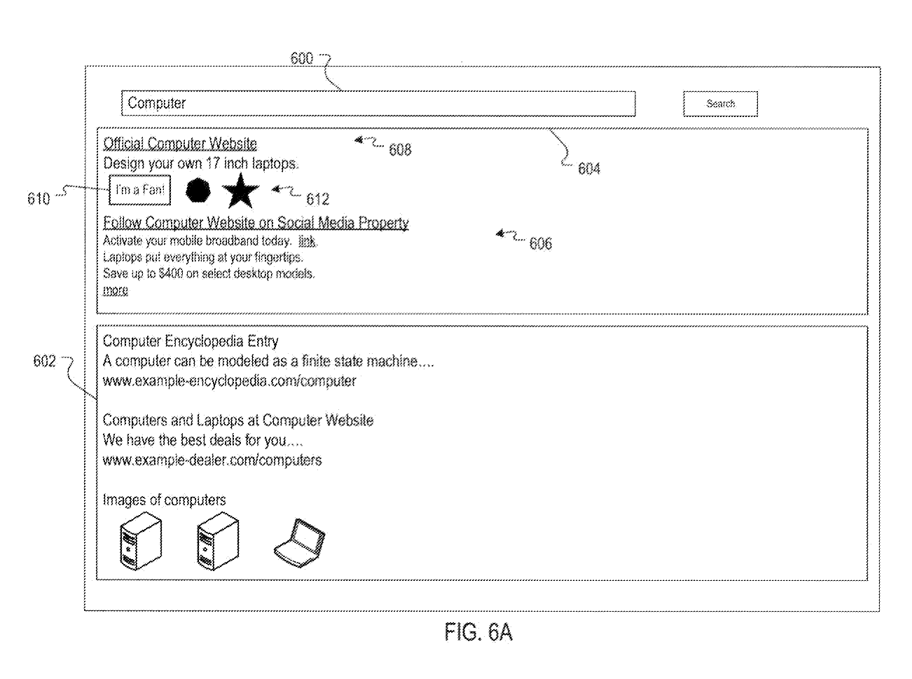

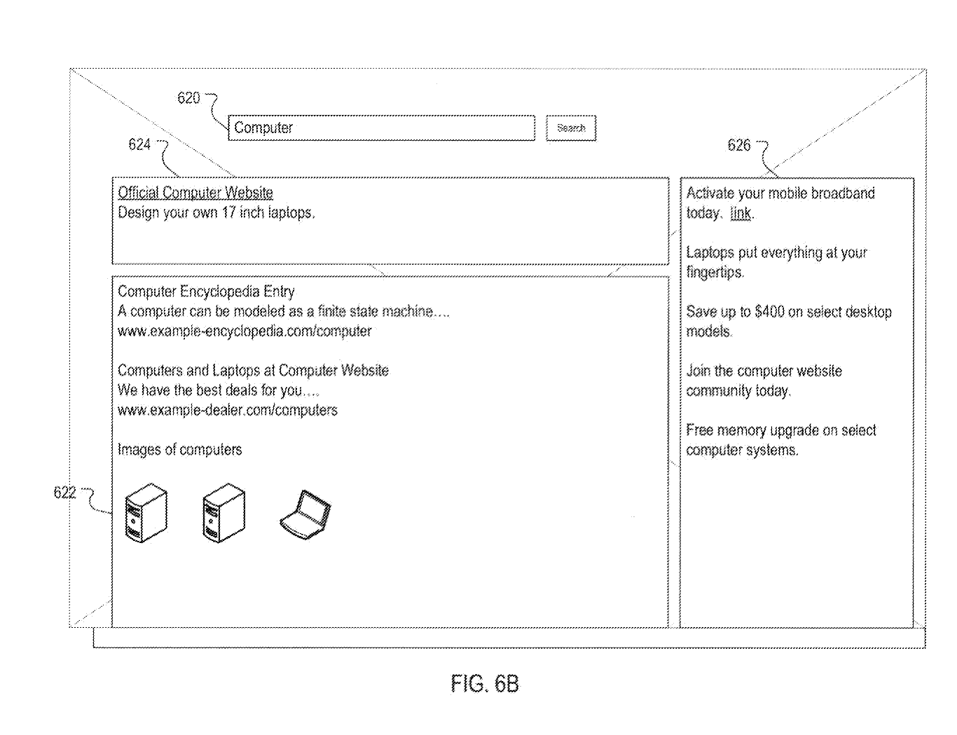

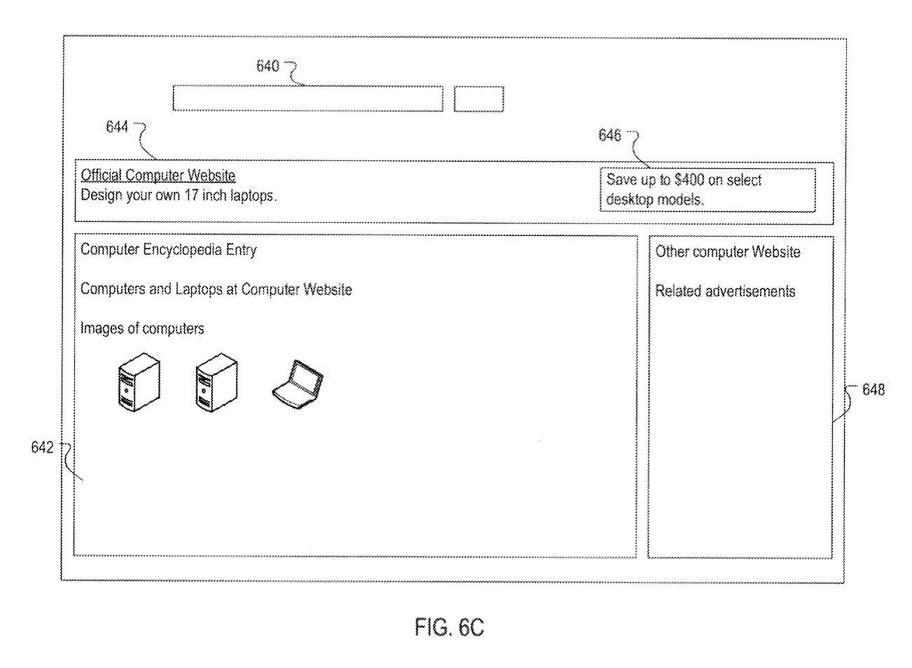

FIGS. 6A-C illustrate exemplary user interfaces for delivering advertisements based on social media content. Referring to FIG. 6A, in this example, a user has entered the search query “computer” in a search text box 600, and initiated a search by a search engine, which provided search results presented in to search results text area 602. The user interface displays advertisements in an advertisement area 604. In this example, an advertisement 606 from an advertising campaign by the advertiser is presented in the same region of the user interface as an advertisement 608 based on the social media content.

In some implementations, the advertisements generated from the social media content of the advertiser can include one or more commands 610 and 612. The commands may be conditioned on whether the user that is viewing the advertisement has an account with the social network property from which the content was collected, i.e., whether the commands are specific to users of the social network. For example, suppose a user that is viewing the advertisement 608 also has an account with the same social network from which the content of the advertiser's account was collected and included in the advertisement 608. Provided the user is logged into the account of the social network (or a corresponding account of the advertisement management system) so that the user can be identified as having an account, a command specific to social network members may be embedded in the advertisement. For example, the social network may have a “fan” status, and fans of a particular account may automatically receive content as it is posted to that account. Accordingly, if the user is not a fan of the advertiser, a command 610 that, upon selection, causes the user's social network account to be associated with the advertisers social network account, can be included with the advertisement.

The commands also need not be specific to users of the social network. For example, if the advertiser has more than one social network property, icons 612 that link to the advertiser's social network properties can also be shown in the advertisement, regardless of whether the user of the user device has an account on any of the social networks.

In some implementations, selection of the advertisement 608 causes the user device of the user to request the resource at the social network property of the advertiser, e.g., to request a page of the advertiser at the social network property, request a text stream, or other associated resource. In other implementations, the advertiser can specify specific landing pages that are different from the social network property.

The actions of the users taken in response to the advertisement, e.g., click throughs and conversions, can also be tracked and used to update the popularity or quality of particular content that is used in the advertisements. For example, assume advertisements that include the content “Design your own 17 inch laptops” have a very low click through rate relative to advertisements that include the content “Save up to $400 on select laptop models.” As a result of the disparity, the content “Save up to $400 on select laptop models” will be selected more often than the content “Design your own 17 inch laptops”, absent other selection parameters.

Additionally, actions taken by users can also result in charges to the advertisers that are in additional to standard auction fees. For example, and advertiser may bid a cost per action based on every 10 followers or fans that result from the advertisement 608, e.g., $20 for every 10 social network users that select command 610.

Referring to FIG. 6B, in this example, a user enters the search “computer” in a search text box 620. Along with search results presented in to search results text area 622 the user interface displays advertisements in an advertisement area 624, 626. In this example, an advertisement from an advertisement campaign by the advertiser is presented in a region 624 separate from the advertisements based on the social media content 626.

Referring to FIG. 6C, in this example, a user enters the search “computer” in a search text box 640. Along with search results presented in to search results text area 642 the user interface displays advertisements in an advertisement area 644. In this example, an advertisement from advertisement campaign by the advertiser is presented in a highlighted position at the top of the page 644. Social media information for the advertiser is present in the same region and off to the side 646. Other advertisements are presented in a separate region without presenting social media advertisements 648.

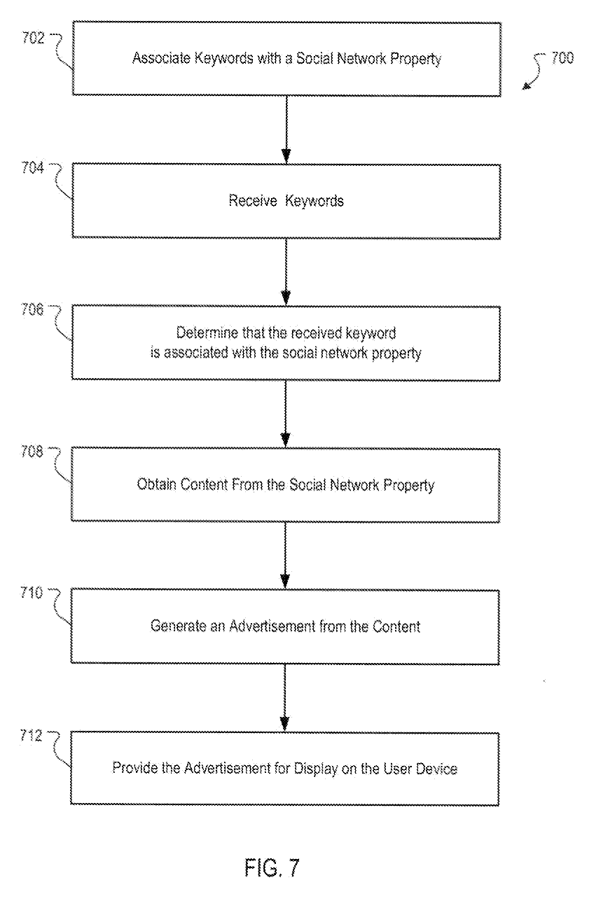

FIG. 7 is a flow diagram of an example process for creating advertisements based on social media content on a social media property. The process 700 can, for example, be implemented in the advertising management system 110 of FIG. 1, or in some other processing system.

The process associates keywords with a social media network property of an advertiser (702). In some implementations, the keywords are provided by the advertiser. In other implementations the keywords are determined from content on the social media network property. In some implementations, keywords are determined from content on the social media network property are re-determined periodically (for example, hourly or daily). In some implementations, only a portion of the social media network content is used to determine keywords. For example, older content may be ignored in favor of newer content. In some implementations, content that is older than one week is ignored. Other time constraints can also be used.

The process receives keywords for an advertisement request (704). In some implementations, the keywords are sent directly from the user device to the advertisement management system. In other implementations, the keywords may be identified from the context in which the user device is operating. For example, keywords may be derived from the content being displayed on the user device.

The process determines that the received keyword is one of the keywords associated with the social media network property (706). Keywords received from the user device are compared to keywords stored by the advertisement management system to determine the advertiser and the social media property associated with the keyword.

The process obtains content posted on the social media network property by the advertiser (708). Advertisers update their social media network property. The advertising management system obtains the social media content from the social media network property. The advertising management system may obtain the social media content by accessing an application programming interface provided by the social media network, or by accessing the webpage associated with the social media network property. In some implementations, social media content are obtained on a regular basis (for example, every 20 minutes) and stored by the advertising management system. In other embodiments, the social media content are obtained from the social media network in response to receiving keywords and advertisement request.

The process generates an advertisement from the content (710). The generated advertisement includes at least some of the content from the social media site. In some embodiments, the advertisement management system prioritizes which content to display as part of an advertisement. The prioritization may be based on a determination of the relevance of the content to the supplied keyword and/or by a measure of the popularity of the content. Content may be considered more popular if the content has resulted in advertisements that resulted in a number of positive user interactions, if the content has been repeated on the social media network, or if users of the social media network have voted favorably for the content.

The process provides the advertisement for display on the user device (712). The advertisement may include instruction that causes the user device to render the advertisement, for example as a portion of a web page. In some embodiments, advertisements based on the social media property are integrated with advertisements as part of a formal advertising campaign.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. (canceled)

2. A method of presenting social network content in a web page outside of the social network, comprising:
receiving, by a system including one or more data processing apparatus and from a user device that is accessing a web page outside of a given social network, a request for content to be presented on the web page being accessed, the request including text;
determining, by the system, that the text in the request matches a term in a social media network property that is part of the given social network;
after receiving the request, identifying, by the system and in response to determining that the text matches the term in the social media network property, additional content from the social media network property; and
generating, by the system and after receiving the request, a content item that includes at least a portion of the additional content from the social media network property; and
providing, by the system and in response to the request, instructions that incorporate, at the user device, the generated content item into a presentation of the web page outside of the given social network.

3. The method of claim 2, further comprising embedding a command specific to the given social network into the generated content item.

4. The method of claim 3, wherein the command enables connection of the user device to the given social network to change a status within the social network from outside of the social network.

5. The method of claim 3, wherein the command enables the user device to automatically receive subsequent content posted to the social media network property as it is posted.

6. The method of claim 2, further comprising prioritizing the additional content from the social medial network property based on a portion of social media users that have distributed the additional content to other social media users.

7. The method of claim 2, further comprising:
identifying second additional content from a second social media network property based on the text, wherein:
generating a content item comprises generating a content item that includes both the additional content and the second additional content.

8. The method of claim 2, wherein identifying additional content comprises accessing, by the system and after receiving the request, the given social network to identify the additional content, wherein the accessing includes accessing one of RSS feed data or social network posts.

9. A system comprising:
one or more computers that are communicatively coupled to a given social network and are configured to access content of a social network property that is part of the given social network; and
one or more storage devices storing instructions that, when executed by the one or more computers, configure the one or more computers to perform operations comprising:
receiving, from a user device that is accessing a web page outside of the given social network, a request for content to be presented on the web page being accessed, the request including text;
determining that the text in the request matches a term in a social media network property that is part of the given social network;
after receiving the request and in response to determining that the text matches the term in the social media network property, identifying additional content from the social media network property; and
generating, after receiving the request, a content item that includes at least a portion of the additional content from the social media network property; and
providing, in response to the request, instructions that incorporate, at the user device, the generated content item into a presentation of the web page outside of the given social network.

10. The system of claim 9, wherein the instructions configure the one or more computers to perform operations comprising embedding a command specific to the given social network into the generated content item.

11. The system of claim 10, wherein the command enables connection of the user device to the given social network to change a status within the social network from outside of the social network.

12. The system of claim 10, wherein the command enables the user device to automatically receive subsequent content posted to the social media network property as it is posted.

13. The system of claim 9, wherein the instructions configure the one or more computers to perform operations comprising prioritizing the additional content from the social medial network property based on a portion of social media users that have distributed the additional content to other social media users.

14. The system of claim 9, wherein the instructions configure the one or more computers to perform operations comprising:
identifying second additional content from a second social media network property based on the text, wherein:
generating a content item comprises generating a content item that includes both the additional content and the second additional content.

15. The system of claim 9, wherein identifying additional content comprises accessing, by the system and after receiving the request, the given social network to identify the additional content, wherein the accessing includes accessing one of RSS feed data or social network posts.

16. A non-transitory computer readable medium storing instructions that,
when executed by one or more computers, cause the one or more computers to perform operations comprising:
receiving, from a user device that is accessing a web page outside of a given social network, a request for content to be presented on the web page being accessed, the request including text;
determining that the text in the request matches a term in a social media network property that is part of the given social network;
after receiving the request and in response to determining that the text matches the term in the social media network property, identifying additional content from the social media network property; and
generating, after receiving the request, a content item that includes at least a portion of the additional content from the social media network property; and
providing, in response to the request, instructions that incorporate, at the user device, the generated content item into a presentation of the web page outside of the given social network.

17. The non-transitory computer readable medium of claim 16, wherein the instructions cause the one or more computers to perform operations comprising embedding a command specific to the given social network into the generated content item.

18. The non-transitory computer readable medium of claim 17, wherein the command enables connection of the user device to the given social network to change a status within the social network from outside of the social network.

19. The non-transitory computer readable medium of claim 17, wherein the command enables the user device to automatically receive subsequent content posted to the social media network property as it is posted.

20. The non-transitory computer readable medium of claim 16, wherein identifying additional content comprises accessing, by the system and after receiving the request, the given social network to identify the additional content, wherein the accessing includes accessing one of RSS feed data or social network posts.
